(19) United States
(12) Patent Application Publication
(10) Pub. No.: US 2026/0280675 A1
(43) Pub. Date: Sep. 17, 2026

(54) Communication Device, Network Node and Methods for Handling Connectivity

(71) Applicant: Telefonaktiebolaget LM Ericsson (publ), Stockholm (SE)

(72) Inventor: Antonino Orsino, Kirkkonummi (FI)

(21) Appl. No.: 19/168,391

(22) PCT Filed: Apr. 5, 2024
(86) PCT No.: PCT/SE2024/050319

§ 371 Date: Sep. 24, 2025

Related U.S. Application Data
(60) Provisional application No. 63/494,254, filed on Apr. 5, 2023.

(51) Int. Cl. H04B 7/06; H04W 76/19

(52) U.S. Cl. CPC H04B 7/06964; H04W 76/19

(57) ABSTRACT

A communication device (200, 330) and method therein for handling connectivity to a network node (311) in a wireless communication network (300) are provided The communication device (200, 330) is configured to communicate with the network node 5 (311) on a control link and a backhaul link, wherein the control link is established between a first module (NCR-MT) of the communication device (200, 330) and the network node (311), the backhaul link is established between a second module (NCR-Fwd) of the communication device (200, 330) and the network node (311). The communication device (200, 330) performs beam monitoring on both the control link and backhaul link; 10 determines whether a beam failure has been detected and a type of the beam failure; and initiates a recovery procedure to the network node (311) based on the type of the beam failure. Publ.

### TECHNICAL FIELD

Embodiments herein relate to communication device, network nodes and methods therein for handling connectivity. In particular, they relate to network controlled repeaters and network nodes for handling beam failure detection and recovery procedures in wireless communication networks.

### BACKGROUND

In a typical wireless communication network, wireless devices, also known as wireless communication devices, mobile stations, or user equipment (UE), communicate via a Radio Access Network (RAN) to one or more core networks (CN). The RAN covers a geographical area which is divided into service areas or cell areas, which may also be referred to as a beam or a beam group, with each service area or cell area being served by a radio network node such as a radio access node e.g., a Wi-Fi access point or a radio base station (BS), which in some networks may also be denoted, for example, a “NodeB” or “eNodeB” or “eNB” or “gNB”. A service area or cell area is a geographical area where radio coverage is provided by the radio network node. The radio network node communicates over an air interface operating on radio frequencies with the wireless communication device within a range of the radio network node.

A Universal Mobile Telecommunications System (UMTS) is a third generation (3G) telecommunication network, which evolved from the second generation (2G) Global System for Mobile Communications (GSM). Specifications for the Evolved Packet System (EPS), also called a Fourth Generation (4G) network or Long Term Evolution (LTE) have been completed within the 3rd Generation Partnership Project (3GPP) and this work continues in the coming 3GPP releases, for example to specify a Fifth Generation (5G) New Radio (NR) network, Next Generation (NG) and upcoming releases.

Repeaters are devices which can be used to improve the coverage of a network node. The repeater will listen to the incoming signal on a frequency and send the same signal but amplified, hence improving the coverage of the network node.

3GPP is in Release 18 (Rel-18) undertaking the work of introducing so called “Network Controlled Repeaters”. Network controlled repeaters are, as the name suggests, allowing the network node to control the operation of the repeater. Example aspects of the repeater which are discussed to be controllable by the network node is when the repeater is turned on and turned off, and which radio beams the repeater is to repeat and not.

The example model that 3GPP is assuming at the moment is depicted in FIG. 1. On the left, an NR base station gNB is shown, and to the right, a UE. In the middle is a Network Controlled Repeater NCR. The NCR consists of two main parts, a forwarding part, NCR-Fwd or repeater-Fwd module which is doing the forwarding operation of taking the signal from the gNB on the so called backhaul link BL or UE on the so-called access link AL and forwarding an amplified version of it that then can be received by the UE on the access link AL or gNB on the backhaul link BL. The other main part is the mobile termination part, NCR-MT or repeater-MT module. This part is what makes the repeater network controllable and allows the gNB to communicate with the repeater. The NCR-MT terminates the control link CL as a UE would do. The link over which the gNB and the repeater communicate is shown as control link CL in FIG. 1.

Since the repeater-Fwd module only amplifies and analogously beamforms the signal, no advanced receiver or transmitter chains are required, which reduce the cost and energy consumption compared to, for example, a normal Transmission and Reception Point (TRP). In its simplest and practical architecture, different antenna modules are used for the BS- and UE-sides, i.e., the antennas targeting the gNB and UEs, respectively, whereas a more complex architecture, including self-interference cancellation, would allow for using the same antenna modules for both sides.

How an NCR will be designed and how it will communicate with the network node is still not clear. FIG. 2 illustrates one schematic example of an NCR 200. In this example, the NCR 200 consists of three principal building blocks, a Modem M 210, a Controller module C 220, and a Repeater module 230 depicted as two amplifiers A in FIG. 2. The NCR 200 is equipped with an antenna configuration, where a signal is first received in downlink or uplink, and, e.g., after power amplification, transmitted further in downlink or uplink. Since the Repeater module 230, also referred to as NCR-Fwd, only amplifies and analogously beamforms the signal, no advanced receiver or transmitter chains are required, which reduce the cost and energy consumption compared to for example a normal Transmission and Reception Point (TRP). In its simplest architecture, different antenna modules UE 240, BS 250 are used for the donor and service sides, i.e., the antennas targeting the gNB and UEs, respectively, whereas a more complex architecture, including self-interference cancellation, would allow for using the same antenna modules for both sides.

The Modem module M 210 is able and used to exchange control and status signaling with a gNB that is controlling the NCR. For this, the Modem module M 210 supports at least a sub-set of UE functions. NCR control and status information is further exchanged between the Modem module M 210 and the Controller module C 220. The Modem module M 210 may be equipped with antennae separated from the antennae used by the Repeater module 230; but in most configurations, the Modem module M 210 and Repeater module 230 will share antenna configurations.

The Controller module C 220 is used to control the Repeater module 230, by for example providing beamforming information, power control information etc. The Controller module C 220 is connected to the network node gNB through the Modem module M 210 such that the network node gNB can control the Controller module C 220 and, in that way, control the Repeater module 230.

Both the Modem and Controller modules 210, 220, may be assumed to be part of building up a Mobile Termination (MT) function in the network-controlled repeater 200.

The Repeater module's amplify-and-forward operation is controlled by the Control module C 220. The Control module C 220 may also be directly responsible for the beamforming control on the service antenna side UE 240, i.e., to/from served UEs. In an alternative, the beamforming on the service antenna side UE 240 is operated by the Repeater module 230 under the control of the Control module C 220. On the donor antenna side BS 250, i.e., to/from the controlling gNB, the Modem module M 210 may be directly responsible for the beamforming control. In an alternative, the beamforming on the service antenna side UE 240 is operated by the Repeater module 230 under the control of the Control module C 220 and/or Modem module M 210.

In one configuration, the Modem module 210 and the Repeater module 230 do not only share an antenna configuration but also parts of the analog transmitter and/or receiver, such as power or transmit amplifier and/or receiver amplifiers and/or filters.

The Modem module 210 and the Repeater module 230 could be operating at the same or different frequencies. For example, the Repeater module 230 may operate at a high frequency band, e.g. the second frequency band (FR2) and the Modem module 210 may operate at a low frequency band, e.g. the first frequency band (FR1).

### Beam Failure Detection and Recovery in NR

A Medium Access Control (MAC) entity may be configured by Radio Resource Control (RRC) per Serving Cell with a beam failure recovery (BFR) procedure which is used for indicating to the serving gNB of a new Synchronization Signal Block (SSB) or Channel State Information Reference Signal (CSI-RS) when beam failure is detected on the serving SSB(s)/CSI-RS(s). Beam failure is detected by counting beam failure instance indication from lower layers to the MAC entity. If beamFailureRecoveryConfig is reconfigured by upper layers during an ongoing Random Access procedure for beam failure recovery for Special Cell (SpCell), i.e. the primary cell of a master or secondary cell group, the MAC entity shall stop the ongoing Random Access procedure and initiate a Random Access procedure using the new configuration.

RRC configures the following parameters in the BeamFailureRecoveryConfig, BeamFailureRecoverySCellConfig, and the RadioLinkMonitoringConfig for the Beam Failure Detection (BFD) and Recovery procedure:
beamFailureInstanceMaxCount for the beam failure detection;
beamFailureDetectionTimer for the beam failure detection;
beamFailureRecoveryTimer for the beam failure recovery procedure;
rsrp-ThresholdSSB: an RSRP threshold for the SpCell beam failure recovery;
rsrp-ThresholdBFR: an RSRP threshold for the SCell beam failure recovery;
powerRampingStep: powerRampingStep for the SpCell beam failure recovery;
powerRampingStepHighPriority: powerRampingStepHighPriority for the SpCell beam failure recovery;
preambleReceivedTargetPower: preambleReceivedTargetPower for the SpCell beam failure recovery;
preambleTransMax: preambleTransMax for the SpCell beam failure recovery;
scalingFactorBI: scalingFactorBI for the SpCell beam failure recovery;
ssb-perRACH-Occasion: ssb-perRACH-Occasion for the SpCell beam failure recovery using contention-free Random Access Resources;
ra-ResponseWindow: the time window to monitor response(s) for the SpCell beam failure recovery using contention-free Random Access Resources;
prach-ConfigurationIndex: prach-ConfigurationIndex for the SpCell beam failure recovery using contention-free Random Access Resources;
ra-ssb-OccasionMaskIndex: ra-ssb-OccasionMaskIndex for the SpCell beam failure recovery using contention-free Random Access Resources;
ra-OccasionList: ra-OccasionList for the SpCell beam failure recovery using contention-free Random Access Resources;
candidateBeamRSList: list of candidate beams for SpCell beam failure recovery;
candidateBeamRSSCellList: list of candidate beams for SCell beam failure recovery.

The following UE variables are used for the beam failure detection procedure:
BFI_COUNTER (per Serving Cell): counter for beam failure instance indication which is initially set to 0.

The MAC entity shall for each Serving Cell configured for beam failure detection:
1> if beam failure instance indication has been received from lower layers:
   2> start or restart the beamFailureDetectionTimer,
   2> increment BFI_COUNTER by 1;
   2> if BFI_COUNTER>=beamFailureInstanceMaxCount:
      3> if the Serving Cell is SCell:
         4> trigger a BFR for this Serving Cell;
      3> else:
         4> initiate a Random Access procedure (see clause 5.1) on the SpCell.
1> if the beamFailureDetectionTimer expires; or
1> if beamFailureDetectionTimer, beamFailureInstanceMaxCount, or any of the reference signals used for beam failure detection is reconfigured by upper layers associated with this Serving Cell:
   2> set BFI_COUNTER to 0.
1> if the Serving Cell is SpCell and the Random Access procedure initiated for SpCell beam failure recovery is successfully completed (see clause 5.1):
   2> set BFI_COUNTER to 0;
   2> stop the beamFailureRecoveryTimer, if configured;
   2> consider the Beam Failure Recovery procedure successfully completed.
1> else if the Serving Cell is SCell, and a PDCCH addressed to C-RNTI indicating uplink grant for a new transmission is received for the HARQ process used for the transmission of the BFR MAC CE or Truncated BFR MAC CE which contains beam failure recovery information of this Serving Cell; or
1> if the SCell is deactivated as specified in clause 5.9:
   2> set BFI_COUNTER to 0;
   2> consider the Beam Failure Recovery procedure successfully completed and cancel all the triggered BFRs for this Serving Cell.

The MAC entity shall:
1> if the Beam Failure Recovery procedure determines that at least one BFR has been triggered and not cancelled for an SCell for which evaluation of the candidate beams according to the requirements as specified in TS 38.133 has been completed:
   2> if UL-SCH resources are available for a new transmission and if the UL-SCH resources can accommodate the BFR MAC CE plus its subheader as a result of LCP:
      3> instruct the Multiplexing and Assembly procedure to generate the BFR MAC CE.
   2> else if UL-SCH resources are available for a new transmission and if the UL-SCH resources can accommodate the Truncated BFR MAC CE plus its subheader as a result of LCP:
      3> instruct the Multiplexing and Assembly procedure to generate the Truncated BFR MAC CE.
   2> else:
      3> trigger the SR for SCell beam failure recovery for each SCell for which BFR has been triggered, not cancelled, and for which evaluation of the candidate beams according to the requirements as specified in TS 38.133 [11] has been completed.

All BFRs triggered for an SCell shall be cancelled when a MAC protocol data unit (PDU) is transmitted and this PDU includes a BFR MAC Control Element (CE) or Truncated BFR MAC CE which contains beam failure information of that SCell.

According to what has been agreed so far in RAN1, i.e. the 3GPP Technical Specification Group Radio Access Network (TSG RAN), RAN WG1, the following is supported regarding the beam failure detection and recovery procedure for NCR:

### Agreement in RAN1#111

As optional functionalities for the NCR-MT, at least Rel-15 legacy BFD/BFR/RLM mechanisms are supported
FFS: The behavior of NCR-Fwd when BFR/RLF happen in C link.

### Agreement in RAN1#112

Once beam failure is detected in C link by NCR-MT, NCR-Fwd is OFF until the beam failure recovery is completed.

From the agreements it is clear that the NCR-MT should perform the Beam Failure Monitoring (BFD) and Beam Failure Recovery (BFR) procedure according to what has been already specified since Rel-15 but only on the control link of the NCR. Further, it has been agreed that the NCR-Fwd should be off until the beam failure recovery procedure is completed.

### SUMMARY

As part of developing embodiments herein problems were identified and will first be discussed.

If one considers that the control link and the backhaul link may work on two different frequencies or two different beams, based on what is agreed there are two main problems:
The NCR will stop forwarding transmission in case the control link has problems, even if the backhaul link may be perfectly fine.
If the NCR-MT failure to do beam failure recovery, the NCR-MT will initiate an RRC reestablishment procedure and thus release the current connection with the gNB, even if the backhaul link may be perfectly fine and may continue to operate normally.

For both the mentioned problems, the end results would be that the UEs served by the NCR will experience a long connectivity interruption that is completely unnecessary if the backhaul link between the NCR-Fwd and the gNB is still good.

Therefore, it is an object of embodiments herein to provide an improved method for handling connectivity between a network node and a communication device with regarding to beam failure monitoring and recovery (BFD/BFR) procedures in a wireless communication network to overcome the aforementioned problems and limitations.

According to one aspect of the embodiments herein, the object is achieved by a communication device and method therein for handling connectivity to a network node in a wireless communication network. The communication device is configured to communicate with the network node on a control link and a backhaul link. The control link is established between a first module, i.e. NCR-MT module, of the communication device and the network node, the backhaul link is established between a second module, i.e. NCR-Fwd module of the communication device and the network node. The communication device is configured to perform beam monitoring on both the control link and backhaul link; determine whether a beam failure has been detected and a type of the beam failure; and initiate a recovery procedure to the network node based on the type of the beam failure.

According to one aspect of the embodiments herein, the object is achieved by a network node and method therein for handling connectivity to a communication device in a wireless communication network. The communication device is configured to communicate with the network node on a control link and a backhaul link. The control link is established between a first module, i.e. NCR-MT module, of the communication device and the network node, the backhaul link is established between a second module, i.e. NCR-Fwd module, of the communication device and the network node. The network node is configured to receive an indication from the communication device indicating a type of a beam failure detected by the communication device performing beam monitoring on both the control link and backhaul link; transmit to the communication device a configuration in order to restore a connectivity to the communication device based on the type of a beam failure.

According to embodiments herein, the communication device, e.g. a UE or an NCR-MT, performs BFD and BFR on both the control link and backhaul link. Once doing it, the UE/NCR-MT may perform one or more of the following actions based on whether the BFD/BFR fails on the control link, backhaul link, or both:
a) If the BFD/BFR fails on the backhaul link and control link:
   The NCR-MT will initiate the RRC reestablishment procedure.
      In this case, the NCR-MT may only perform BFD on the backhaul link.
b) If the BFD/BFR fails on the backhaul link but not on the control link:
   The NCR-MT will not trigger the RRC reestablishment procedure but instead will report to the gNB that the backhaul link has failed.
      In this case, the NCR-MT may only perform BFD on the backhaul link.
c) If the BFD/BFR fails on the control link but not on the backhaul link:
   The NCR-MT initiate the RRC reestablishment procedure and at the same time will indicate to the gNB that the backhaul link is still good and does not need to be reconfigured.
   The NCR-MT may decide to keep the NCR-Fwd status as ON if the backhaul link is still good and there are transmission still ongoing with UEs served by the NCR.

The methods and solutions proposed and disclosed herein aim and allow the NCR-MT to perform BFD and BFR procedure on the backhaul link and, by doing this, preventing to initiate a RRC reestablishment procedure as far as the backhaul link is still good.

This will basically avoid a long connectivity interruption for the UEs served by the NCR, in case the backhaul link is still good and in turn this will also avoid high energy consumption for those UEs served by the NCR.

### BRIEF DESCRIPTION OF THE DRAWINGS

Examples of embodiments herein are described in more detail with reference to attached drawings in which:

FIG. 1 is a schematic block diagram illustrating an example of communication between a network-controlled repeater (NCR) and a network node;

FIG. 2 is a schematic block diagram illustrating an example of a network-controlled repeater with building blocks;

FIG. 3 is a schematic block diagram illustrating a wireless communication network;

FIG. 4 is a flow chart illustrating an example embodiment of a method performed in a communication device according to embodiments herein;

FIG. 5 is a flow chart illustrating an example embodiment of a method performed in a network node according to embodiments herein;

FIG. 6 is a schematic block diagram illustrating an example embodiment of a communication device; and

FIG. 7 is a schematic block diagram illustrating an example embodiment of a network node.

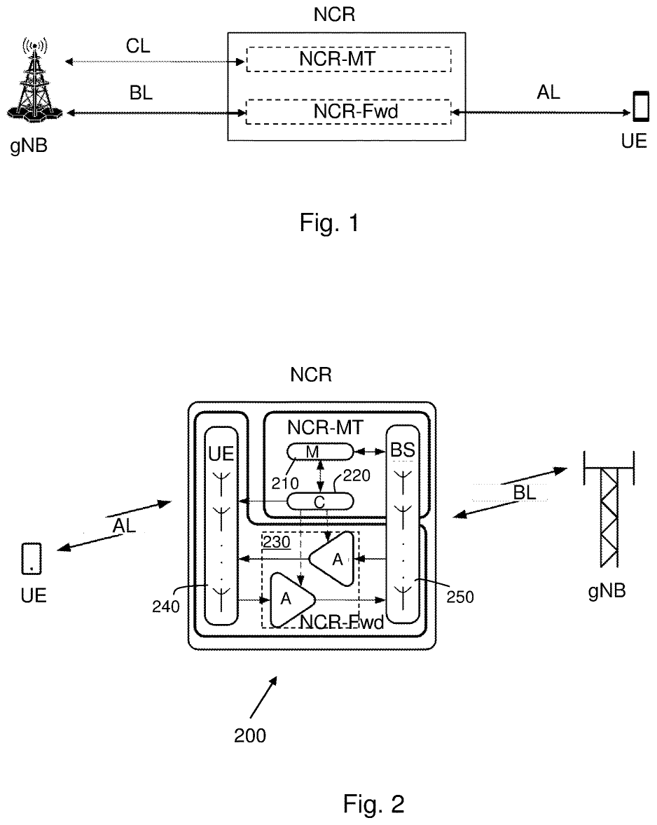

### DETAILED DESCRIPTION

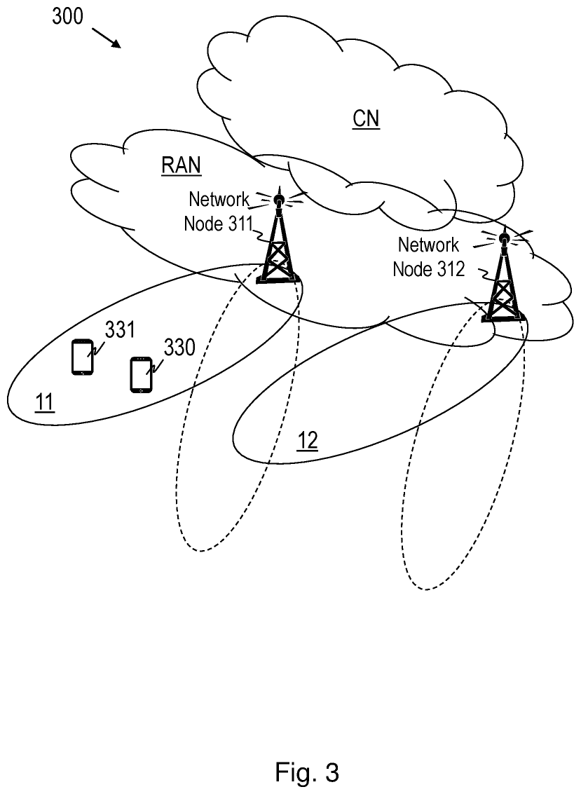

Embodiments herein relate to communication networks in general. FIG. 3 is a schematic overview depicting a communication network 300. The communication network 300 may be a wireless communication network comprising one or more RANS, and one or more CNs. The communication network 300 may use a number of different RATs, such as Wi-Fi, Long Term Evolution (LTE), LTE-Advanced, NR, Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), NR etc. just to mention a few possible implementations.

In the wireless communication network 300, one or more wireless communication devices 330, 331 such as a UE, a mobile station, a repeater, a network controlled repeater or a wireless terminal communicates via one or more RANs to one or more CNs. It should be understood by the skilled in the art that “wireless communication device” is a non-limiting term which means any terminal, wireless communication terminal, user equipment, Machine Type Communication (MTC) device, Device to Device (D2D) terminal, or node e.g. smart phone, laptop, mobile phone, sensor, relay, mobile tablets or even a small base station communicating within a cell.

Network nodes operate in the wireless communication network 300 such as a first network node 311, a second network node 312. The first and second network nodes 311, 312 may be any of RAN node, such as gNB, eNB, en-gNB, ng-eNB, gNB etc. The first network node 311 provides radio coverage over a geographical area, a service area 11, which may also be referred to as a beam or a beam group where the group of beams is covering the service area of a first radio access technology (RAT), such as 5G, LTE, Wi-Fi or similar. The second network node 312 provides radio coverage over a geographical area, a service area 12, which may also be referred to as a beam or a beam group where the group of beams is covering the service area of a second radio access technology (RAT), such as 5G, LTE, Wi-Fi or similar. It should be noted that a network node may be a RAN node, a CN node or an OAM node.

The first/second network nodes 311/312 may be a transmission and reception point e.g. a radio access network node such as a Wireless Local Area Network (WLAN) access point or an Access Point Station (AP STA), an access controller, a base station, e.g. a radio base station such as a NodeB, a gNB, an evolved Node B (eNB, eNode B), a base transceiver station, a radio remote unit, an Access Point Base Station, a base station router, a transmission arrangement of a radio base station, a stand-alone access point or any other network unit capable of communicating with a wireless communication device within the service area served by the respective first/second network nodes 311/312 depending e.g. on the radio access technology and terminology used. The first and the second network nodes 311/312 may be referred to as a source and a target network node, respectively, and may communicate with the wireless communication device 330, 331 with Downlink (DL) transmissions to the wireless communication device 330, 331 and Uplink (UL) transmissions from the wireless communication device 330, 331.

In the following, the terms “communication device”, “wireless terminal”, “NCR-MT”, “NCR-MT node/module/part/entity”, “NCR-Fwd”, “NCR-Fwd node/module/part/entity”, “repeater node”, “repeater”, “NCR node” and “UE” may be used interchangeably. The term “network node”, “gNB”, “eNB”, “gNodeB” may be used interchangeably.

A network node may be a RAN node, a gNB, an eNB, an en-gNB, a ng-eNB, a gNB-CU, a gNB-CU-CP, a gNB-CU-UP, an eNB-CU, an eNB-CU-CP, an eNB-CU-UP, an IAB-node, an IAB-donor DU, an IAB-donor-CU, an IAB-DU, an IAB-MT, an O-CU, an O-CU-CP, an O-CU-UP, an O-DU, an O-RU, an O-eNB, a Non-Real Time RAN Intelligent Controller (Non-RT RIC), a Real-Time RAN Intelligent Controller (RT-RIC), an OAM node, a Core Network node/function, a Cloud-based network function, a Cloud-based centralized training node, a node hosting NR PDCP etc.

In the embodiments and text of the disclosure it is referred to methods for a communication device or UE, but these methods may also be applied without any loss of generality to an NCR-MT of an NCR node. This is because effectively the NCR-MT part of the NCR can be considered as a UE.

Also, the embodiments are written in the context of NR, but they can be applied without any loss of meaning also to other radio access technologies that allow a network node to control a repeater node.

The scenario targeted herein is when the UE or NCR-MT performs BFD and BFR on the control link and, at the same time, also on the backhaul link. Since the backhaul link is between the NCR-Fwd entity and the network node, the assumption is that the NCR-MT is able to monitor the beams on the NCR-Fwd entity via an internal interface between the NCR-MT and NCR-Fwd that, however, is unspecified.

Please note that in the present disclosure, how the NCR-MT performs BFD and BFR on the backhaul link is out of scope. However, it is assumed that the NCR-MT is able to do BFD and BFR on the backhaul link according to its own implementation.

Note, an NCR-MT may be able to operate as, and communicate with a network node as if it is, a normal UE, i.e. not an entity within the NCR. When it herein says that the NCR-MT should be turned on or off, it may only impact the device from acting as an NCR-MT. However, the state of the NCR i.e., ON or OFF, is completely decoupled from the RRC state of the NCR-MT and thus these two “states” operate independently. The NCR-MT may for example connect to the network node to acquire configurations, or download updates, etc. and when it does so it may act towards the network node as if it is not an NCR-MT. The on/off indications may not impact the device's operation with regards to connecting to the network node for such other purposes.

### Embodiment A

A group of methods for a UE with network controlled repeater capabilities, i.e., NCR-MT, for restoring a connectivity on a control link or a backhaul link of an NCR node.

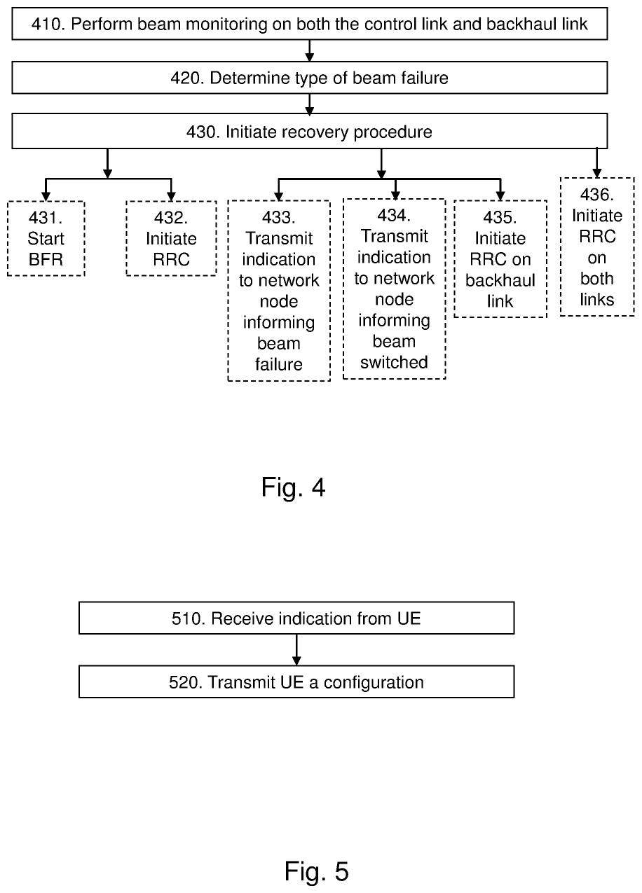

A method performed in a communication device, e.g. UE 330 or NCR 200 or NCR-MT module of NCR 200, for handling connectivity to a network node, e.g. the first network node 311 in a wireless communication network 300, will be described with reference to FIG. 4. The communication device 200/330 is configured to communicate with the network node 311 on a control link and a backhaul link, wherein the control link is established between a first module, e.g. NCR-MT module, of the communication device 200/330 and the network node 311, the backhaul link is established between a second module, e.g. NCR-Fwd module, of the communication device 200/330 and the network node 311. The method comprises the following actions which may be performed in any suitable order.

### Action 410

The communication device 200/330 performs beam monitoring on both the control link and backhaul link. The control link and backhaul link are established between the NCR node/communication device 200/330 and the network node 311.

According to some embodiments herein, the beam monitoring may be performed independently on each link i.e., the control link and the backhaul link using a first beam monitoring process for the control link and a second monitoring process for the backhaul link. In this case, the UE i.e., NCR-MT has a beam monitoring process for the control link and a separate monitor process for the backhaul link. Due to this, when a failure is detected on one link this will not stop the beam monitor process on the other link. Also, the UE i.e., NCR-MT, may be configured with different configurations for each link on which the beam monitoring needs to be done.

According to some embodiments herein, the beam monitoring may be performed jointly on each link i.e., the control link and the backhaul link using one monitoring process on both the control link and the backhaul link. In this case, the UE i.e., NCR-MT, will perform the beam monitoring on a pool of beams that includes the beams belonging to the control link and the beams belonging to the backhaul link. Also, since there only one beam monitoring process activates at the UE, when a failure is detected, this will affect both the control and backhaul link. Further, in this case the UE i.e., NCR-MT may be configured only with one configuration since the beam monitoring is done jointly on the control and backhaul link.

### Action 420

The communication device 200/330 determines whether a beam failure has been detected and a type of the beam failure. The communication device 200/330 may detect a beam failure either on the control link or backhaul link or both.

According to some embodiments herein, the beam failure detected by the communication device 200/330 or UE i.e., NCR-MT, may include one or more of the following:
a) A beam failure is detected only on the control link while the backhaul link is still in good conditions.
b) A beam failure is detected only on the backhaul link while the control link is still in good conditions.
c) A beam failure is detected on both the control link and backhaul link.

According to some embodiments herein, the communication device 200/330 or UE i.e., NCR-MT, may determine that a beam failure has been detected on both the control link and backhaul link when one or more of the following conditions are fulfilled:
1) The beam failure on one link has been detected within a timer “T” after the beam failure has been detected on the other link.
2) The beam failure on one link has been detected before the connectivity was restored e.g. due to a detection of beam failure on the other link.
3) The beam failure on one link has been detected before a recovery procedure e.g. due to a detection of beam failure has been initiated on the other link.

### Action 430

The communication device 200/330 initiates a recovery procedure to the network node 311 based on the type of the beam failure.

According to some embodiments herein, the recovery procedure initiated by the communication device 200/330 or UE i.e., NCR-MT, after that a beam failure has been detected can imply one or more of the following actions:
a) Initiating a beam failure recovery procedure in order to select a new beam between the NCR/communication device 200/330 and the network node on which to transmit and receive.
b) Initiating a Radio Resource Control (RRC) reestablishment procedure in order to restore the entire connectivity between the NCR/communication device 200/330 and the network node 311.
c) Transmitting an indication to the network node 311 for informing that a beam failure has been detected e.g. either on the control link or backhaul link.

According to some embodiments herein, the beam failure recovery procedure initiated by the communication device 200/330 or UE i.e., NCR-MT, is different depending on whether the beam failure has been detected on the control link or the backhaul link. Please, keep in mind that, according to the legacy procedure for beam monitoring, when the UE performs BFD on a link, the outcome of this procedure is a beam, usually the best beam, on which the UE will perform a BFR, meaning that the UE will try to restore the connectivity over the new beam that has been selected during the BFD.

According to some embodiments herein, if the beam failure has been detected on the control link, the communication device 200/330 or UE i.e., NCR-MT, may initiate one or more of the following actions:

### Action 431

The communication device 200/330 or UE i.e., NCR-MT may start the BFR procedure in order to restore the connectivity over the control link and, at the same time, inform the network node 311 that the connectivity/beam over the backhaul link is still in good condition. While the BFR procedure can be done according to the legacy procedure, a new aspect is that the communication device 200/330 or UE i.e., NCR-MT, needs to indicate to the network node 311 about the radio condition on the backhaul link. This may be done according to one or more of the following options:
1) The UE i.e., NCR-MT, may use a special Random Access Channel (RACH) preamble when performing BFR and the use of this special RACH preamble implicitly or explicitly inform the network node that the backhaul link is still good. Implicitly means the presence of the special RACH preamble itself while explicitly means the presence of a field or a value or a parameter within the RACH preamble.
2) The UE i.e., NCR-MT, may indicate that the radio conditions over the backhaul link are still good within the MAC Control Element (CE) e.g. in msg3, that is used for content resolution. This may be a new MAC CE or an existing one where some reserved bit is used for this purpose.
3) The UE i.e., NCR-MT, may indicate that the radio conditions over the backhaul link are still good after the BFR procedure is concluded or after the connection over the control link has been restored. In such a case the UE i.e., NCR-MT, has restored the connection of the control link and it may use a signaling over L1, MAC, RRC to indicate to the network node that the radio conditions over the backhaul link are still good. Also, please note that here restoring the connection over the control link may mean that the BFR has been successful or that the RRC reestablishment procedure has been completed e.g. in case the BFR procedure has failed.

### Action 432

The communication device 200/330 or UE i.e., NCR-MT, may initiate an RRC reestablishment procedure in order to restore the connectivity over the control link and, at the same time, inform the network node 311 that the connectivity/beam over the backhaul link is still in good condition.

In this case, the UE i.e., NCR-MT, may indicate that the radio conditions over the backhaul link are still good after the connection over the control link has been restored. In such a case the UE i.e., NCR-MT, has restored the connection of the control link and it may use a signaling over L1, MAC, RRC to indicate to the network node 311 that the radio conditions over the backhaul link are still good. Also, please note that here restoring the connection over the control link means that the RRC reestablishment procedure, initiated because the BFR has failed, has been completed.

According to some embodiments herein, if the beam failure has been detected on the backhaul link, the communication device 200/330 or UE i.e., NCR-MT, may initiate one or more of the following actions:

### Action 433

The communication device 200/330 or UE i.e., NCR-MT, may transmit an indication to the network node for informing that a beam failure detection happened on the backhaul link. In such a case, the indication is transmitted over the control link via e.g., L1, MAC CE, or RRC signaling.
a) In one option, the indication may be a single bit indication just to indicate whether or not a beam failure detection has happened on the backhaul link.
b) In one option, the indication may be a single bit indication just to indicate whether or not a beam failure detection has happened on the backhaul link but it may also comprise one or more of the following:
   a) Which beam has been selected as outcome of the BFD procedure.
   b) A set of preferred beams to which the NCR-Fwd can be switched in order to maintain the connection with the network node over the backhaul link.
   c) A beam index to indicate that the NCR-Fwd has been switched to a certain beam.
   d) An indication about the current status of the NCR-Fwd e.g., ON or OFF, regardless of what was previously indicated by the network node 311.

### Action 434

The communication device 200/330 or UE i.e., NCR-MT, may transmit an indication to the network node 311 for informing that, due to a beam failure detection happened on the backhaul link, the NCR-Fwd has been autonomously switched i.e., by the NCR-MT to another beam. In such a case, the indication is transmitted over the control link via e.g., L1, MAC CE, or RRC signaling.
a) In one option, the indication may be a single bit indication just to indicate which is the current beam on which the NCR-Fwd is operating and thus the network node 311 may understand implicitly that the beam was changed.
b) In one option, the indication may be a single bit indication just to indicate which is the current beam on which the NCR-Fwd is operating and thus the network node 311 may understand implicitly that the beam was changed but it may also comprise one or more of the following:
   1) Which beam has been selected as outcome of the BFD procedure.
   2) A set of preferred beams to which the NCR-Fwd can be switched in order to maintain the connection with the network node 311 over the backhaul link.
   3) An indication about the current status of the NCR-Fwd e.g., ON or OFF, regardless of what was previously indicated by the network node 311.

### Action 435

The communication device 200/330 or UE i.e., NCR-MT, may initiate an RRC reestablishment procedure in order to restore the connectivity over the backhaul link and, at the same time, inform the network node that the connectivity/beam over the backhaul link is still in good condition. Please note that in this case also the control link will be reconfigured due to the RRC reestablishment procedure, even if the control link was not having any problems.

In this case, once the UE i.e., NCR-MT, has restored the connection of the control link after the completion of the RRC reestablishment procedure, it may use a signaling over L1, MAC, RRC to indicate to the network node that the radio conditions over the backhaul link are still good.

Note that the NCR-MT does not start any BFR procedure over a beam in which the NCR-Fwd may operate as the random access procedure for an NCR-Fwd is not supported and thus, as a consequence, the BFR procedure is also not supported.

According to some embodiments herein, if the beam failure has been detected on the backhaul link and on the control link, the UE i.e., NCR-MT, may initiate, in Action 436, an RRC reestablishment procedure to restore the connectivity on both the backhaul link and control link.

According to some embodiments herein, it is the NCR-MT itself that performs beam monitoring on the beams in which the NCR-Fwd is operating and on its own beams.

According to some embodiments herein, it is the NCR-MT performs beam monitoring on the beams in which it is operating and the NCR-Fwd performs beam monitoring on the beams in which it is operating. In this case, the NCR-Fwd will inform the NCR-MT if any problem is detected via an internal interface between the NCR-MT and the NCR-Fwd.

### Embodiment B

A group of methods for a network node 311 i.e., a gNB, for restoring a connectivity on the control link or a backhaul link of an NCR node.

A method performed in a network node 311 for handling connectivity to a communication device or NCR 200/330 in a wireless communication network 300, will be described with reference to FIG. 5. The communication device 200/300 is configured to communicate with the network node 311 on a control link and a backhaul link, wherein the control link is established between a first module, e.g. NCR-MT module of the communication device 200/330 and the network node 311, the backhaul link is established between a second module, e.g. NCR-Fwd module of the communication device 200/330 and the network node 311. The method comprises the following actions which may be performed in any suitable order.

### Action 510

The network node 311 receives an indication from the communication device 200/330, e.g. UE or NCR-MT, indicating a type of a beam failure detected by the communication device 200/330 performing beam monitoring on both the control link and backhaul link. This is to inform the network node 311 that a beam failure has been detected on the control link with the communication device 200/330 or NCR, a backhaul link with the communication device 200/330 or NCR, or both.

According to some embodiments herein, the indication received from the communication device 200/330 or UE i.e., the NCR-MT, may include one or more of the following:
a) An indication that a beam failure has happened on the control link.
b) An indication that a beam failure has happened on the backhaul link.
c) An indication that a beam failure has happened on both the control link and backhaul link.
d) Which beam has been selected as outcome of the BFD procedure.
e) A set of preferred beams to which the NCR-Fwd may be switched in order to maintain the connection with the network node 311 over the backhaul link.
f) a beam index to indicate that the NCR-Fwd has been switched to a certain beam.
g) An indication about the current status of the NCR-Fwd e.g., ON or OFF, regardless of what was previously indicated by the network node 311.

### Action 520

The network node transmits to the communication device 200/330, i.e. UE or NCR-MT, a new configuration in order to restore a connectivity to the communication device 200/330 based on the type of a beam failure, i.e. the connectivity with the control link with the communication device 200/330 or NCR, a backhaul link with the communication device 200/330 or NCR, or both.

According to some embodiments herein, the network node 311 may indicate to the communication device 200/330 or NCR-MT in a new configuration one or more of the following:
a) A beam index on which the NCR-Fwd needs to be switched.
b) A new status for the NCR-Fwd e.g., ON or OFF.
c) A beam index on which the NCR-MT needs to be switched.
d) A new set of parameters or values or fields to be used by the NCR-MT (that does not necessarily lead to a change of beam).
e) A new set of parameters or values or fields to be used by the NCR-Fwd (that does not necessarily lead to a change of beam).

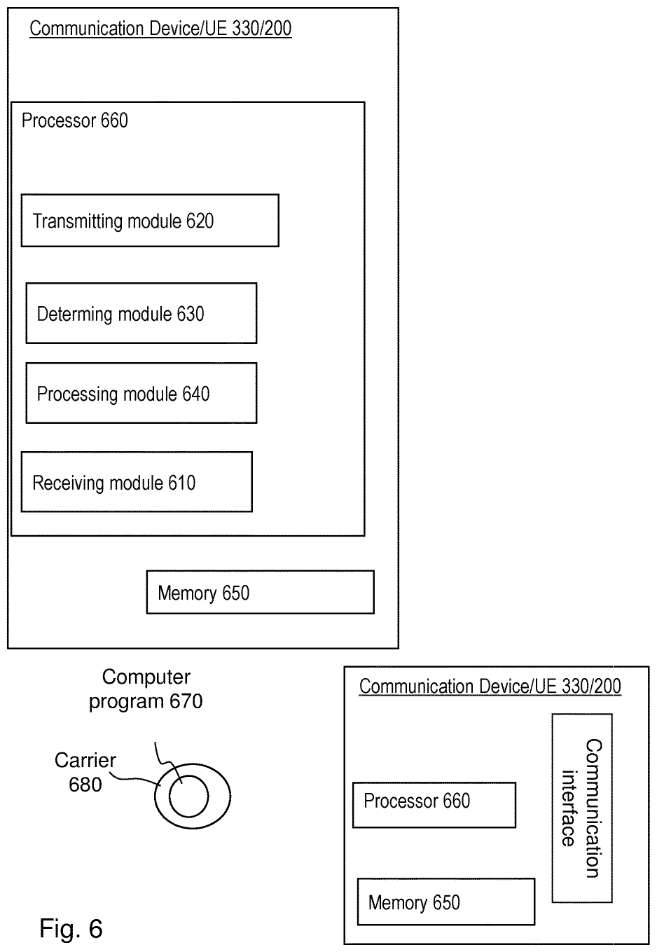

To perform the methods in the communication device, the communication device comprises modules as shown in FIG. 6. The communication device comprises a receiving module 610, a transmitting module 620, a determining module 630, a processing module 640, a memory 650 etc.

The communication device is configured to perform any one of the Actions 410-436 described above.

The methods according to embodiments herein may be implemented through one or more processors, such as the processor 660 in the communication device together with computer program code for performing the functions and actions of the embodiments herein. The program code mentioned above may also be provided as a computer program product, for instance in the form of computer readable medium or a data carrier 680 carrying computer program code 670, as shown in FIG. 6, for performing the embodiments herein when being loaded into the communication device/UE 330/200. One such carrier may be in the form of a CD ROM disc. It is however feasible with other data carriers such as a memory stick. The computer program code may furthermore be provided as pure program code on a server or a cloud and downloaded to the communication device/UE 330/200.

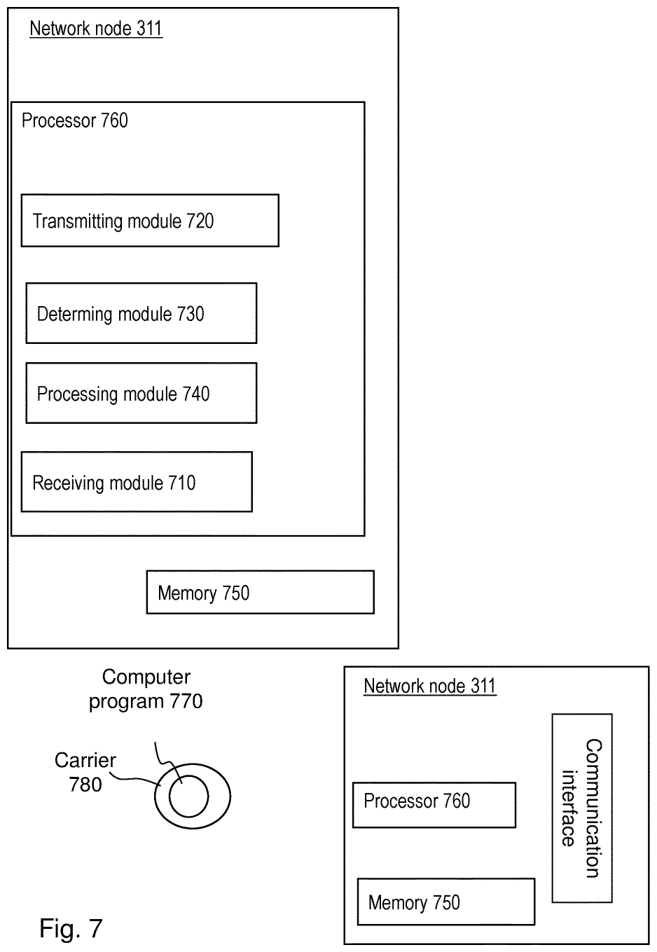

To perform the methods in the network node 311, the network node 311 comprises modules as shown in FIG. 7. The network nodes 311 comprises a receiving module 710, a transmitting module 720, a determining module 730, a processing module 740, a memory 750 etc.

The network node 311 is configured to perform any one of the Actions 510-520 described above.

The methods according to embodiments herein may be implemented through one or more processors, such as the processor 760 in the first network node 311 together with computer program code for performing the functions and actions of the embodiments herein. The program code mentioned above may also be provided as a computer program product, for instance in the form of computer readable medium or a data carrier 780 carrying computer program code 770, as shown in FIG. 7, for performing the embodiments herein when being loaded into the first network nodes 311. One such carrier may be in the form of a CD ROM disc. It is however feasible with other data carriers such as a memory stick. The computer program code may furthermore be provided as pure program code on a server or a cloud and downloaded to the first network node 311.

Some example embodiments are listed in the following:

Embodiment 1. A method performed in a communication device for handling connectivity to a network node in a wireless communication network, wherein the communication device is configured to communicate with the network node on a control link and a backhaul link, wherein the control link is established between a first module (NCR-MT) of the communication device and the network node, the backhaul link is established between a second module (NCR-Fwd) of the communication device and the network node, the method comprising:
performing (410) beam monitoring on both the control link and backhaul link;
determining (420) whether a beam failure has been detected and a type of the beam failure; and
initiating (430) a recovery procedure to the network node based on the type of the beam failure.

Embodiment 2. The method according to Embodiment 1, wherein the beam monitoring is performed independently on each link using a first beam monitoring process for the control link and a second monitoring process for the backhaul link.

Embodiment 3. The method according to Embodiment 1, wherein the beam monitoring is performed jointly on each link using one monitoring process on both the control link and the backhaul link.

Embodiment 4. The method according to any one of Embodiments 1-3, wherein the type of the beam failure comprises one or more of the following:
a) A beam failure is detected only on the control link while the backhaul link is still in good conditions.
b) A beam failure is detected only on the backhaul link while the control link is still in good conditions.
c) A beam failure is detected on both the control link and backhaul link.

Embodiment 5. The method according to Embodiment 4, wherein the type of the beam failure is determined to be “c) A beam failure is detected on both the control link and backhaul link”, when one or more of the following conditions are fulfilled:
1) The beam failure on one link has been detected within a time period after the beam failure has been detected on the other link.
2) The beam failure on one link has been detected before a connectivity was restored on the other link.
3) The beam failure on one link has been detected before a recovery procedure has been initiated on the other link.

Embodiment 6. The method according to any one of Embodiments 1-5, wherein initiating a recovery procedure comprising one or more of the following:
i. initiating a beam failure recovery procedure in order to select a new beam on which to transmit and receive.
ii. initiating a Radio Resource Control, RRC, reestablishment procedure in order to restore an entire connectivity between the communication device and the network node.
iii. transmitting an indication to the network node for informing that a beam failure has been detected either on the control link or backhaul link.

Embodiment 7. The method according to any one of Embodiments 1-6, wherein if a beam failure has been detected on the control link, initiating a recovery procedure comprises one or more of the following:
a) initiating (431) a Beam Failure Recovery, BFR, procedure in order to restore a connectivity over the control link and, at the same time, informing the network node that the connectivity (beam) over the backhaul link is still in good condition.
b) initiating (432) an RRC reestablishment procedure in order to restore a connectivity over the control link and, at the same time, informing the network node that the connectivity (beam) over the backhaul link is still in good condition.

Embodiment 8. The method according to any one of Embodiments 1-6, wherein if a beam failure has been detected on the backhaul link, initiating a recovery procedure comprises one or more of the following:
A. transmitting (433) an indication to the network node for informing that a beam failure has been detected on the backhaul link.
B. transmitting (434) an indication to the network node for informing that, due to a beam failure has been detected on the backhaul link, the second module (NCR-Fwd) has been autonomously switched to another beam.
C. initiating (435) an RRC reestablishment procedure in order to restore a connectivity over the backhaul link and informing the network node that the connectivity (beam) over the backhaul link is still in good condition.

Embodiment 9. The method according to any one of Embodiments 1-6, wherein if a beam failure has been detected on the backhaul link and on the control link, initiating a recovery procedure comprises initiating an RRC reestablishment procedure to restore a connectivity on both the backhaul link and control link.

Embodiment 10. The method according to any one of Embodiments 1-9, wherein beam monitoring is performed by the first module (NCR-MT) on the beams the first module (NCR-Fwd) is operating on and on its own beams.

Embodiment 11. The method according to any one of Embodiments 1-9, wherein beam monitoring is performed by the first module (NCR-MT) and second module (NCR-Fwd) on their operating beams respectively, and the second module (NCR-Fwd) informs the first module (NCR-MT) when a beam failure is detected.

Embodiment 12. A communication device for handling connectivity to a network node in a wireless communication network, wherein the communication device is configured to communicate with the network node on a control link and a backhaul link, wherein the control link is established between a first module (NCR-MT) of the communication device and the network node, the backhaul link is established between a second module (NCR-Fwd) of the communication device and the network node, the communication device is configured to perform the method according to any one of Embodiments 1-11.

Embodiment 13. A method performed in a network node for handling connectivity to a communication device in a wireless communication network, wherein the communication device is configured to communicate with the network node on a control link and a backhaul link, wherein the control link is established between a first module (NCR-MT) of the communication device and the network node, the backhaul link is established between a second module (NCR-Fwd) of the communication device and the network node, the method comprising:
receiving (510) an indication from the communication device indicating a type of a beam failure detected by the communication device performing beam monitoring on both the control link and backhaul link;
transmitting (520) to the communication device a configuration in order to restore a connectivity to the communication device based on the type of a beam failure.

Embodiment 14. The method according to Embodiment 1, wherein the indication received from the communication device comprises one or more of the following:
a) An indication indicating a beam failure has been detected on the control link.
b) An indication indicating a beam failure has been detected on the backhaul link.
c) An indication indicating a beam failure has been detected on both the control link and backhaul link.
d) An indication indicating which beam has been selected as an outcome of the beam monitoring procedure performed by the communication device.
e) A set of preferred beams to which the second module (NCR-Fwd) can be switched in order to maintain the connection with the network node over the backhaul link.
f) A beam index indicating that the second module (NCR-Fwd) has been switched to a certain beam.
g) An indication indicating the current status of the second module (NCR-Fwd) regardless of what was previously indicated by the network node.

Embodiment 15. The method according to Embodiment 1, wherein the configuration transmitted by the network node comprises one or more of the following:
a) A beam index on which the second module (NCR-Fwd) needs to be switched.
b) A new status for the second module (NCR-Fwd).
c) A beam index on which the first module (NCR-MT) needs to be switched.
d) A new set of parameters or values or fields to be used by the first module (NCR-MT).
e) A new set of parameters or values or fields to be used by the second module (NCR-Fwd).

Embodiment 16. A network node for handling connectivity to a communication device in a wireless communication network, wherein the communication device is configured to communicate with the network node on a control link and a backhaul link, wherein the control link is established between a first module (NCR-MT) of the communication device and the network node, the backhaul link is established between a second module (NCR-Fwd) of the communication device and the network node, the network node is configured to perform the method according to any one of Embodiments 13-15.

1.-21. (canceled)

22. A method performed in a communication device configured for operation in a wireless communication network, the method comprising:
performing beam monitoring on the following:
a control link between a first module (NCR-MT) of the communication device and a network node of the wireless communication network, and
a backhaul link between a second module (NCR-Fwd) of the communication device and the network node;
based on the beam monitoring, determining that a beam failure was detected and a type of the beam failure; and
initiating a recovery procedure to the network node based on the type of the beam failure.

23. The method according to claim 22, wherein the beam monitoring is performed using a first beam monitoring process for the control link and a second monitoring process for the backhaul link, wherein the first and second beam monitoring processes are performed independently.

24. The method according to claim 22, wherein the beam monitoring is performed jointly based on one monitoring process used for both the control link and the backhaul link.

25. The method according to claim 22, wherein the type of the beam failure is determined to be one of the following:
a beam failure on the control link with no beam failure on the backhaul link;
a beam failure on the backhaul link with no beam failure on the control link; or
beam failures on both the control link and the backhaul link.

26. The method according to claim 25, wherein the type of the beam failure is determined to be beam failures on both the control link and the backhaul link when one or more of the following conditions are fulfilled:
the beam failure was detected on one of the control link and the backhaul link within a time period after the beam failure was detected on the other of the control link and the backhaul link;
the beam failure was detected on one of the control link and the backhaul link before a connectivity was restored on the other of the control link and the backhaul link; and
the beam failure was detected on one of the control link and the backhaul link before a recovery procedure was initiated on the other of the control link and the backhaul link.

27. The method according to claim 22, wherein initiating a recovery procedure comprising one or more of the following:
initiating a beam failure recovery procedure to select a new beam on which to transmit and receive;
initiating a Radio Resource Control (RRC) reestablishment procedure to restore connectivity between the communication device and the network node; and
transmitting to the network node an indication that a beam failure was detected on the control link or the backhaul link.

28. The method according to claim 22, wherein when a beam failure is detected on the control link, initiating a recovery procedure comprises informing the network node that a beam of the backhaul link is still in good condition and initiating one or more of the following to restore connectivity over the control link:
a Beam Failure Recovery (BFR) procedure; and
a radio resource control (RRC) reestablishment procedure.

29. The method according to claim 22, wherein when a beam failure is detected on the backhaul link, initiating a recovery procedure comprises one or more of the following:
transmitting to the network node an indication that a beam failure was detected on the backhaul link;
transmitting to the network node an indication that the second module (NCR-Fwd) has been autonomously switched to another beam due to a beam failure detected on the backhaul link; and
initiating a radio resource control (RRC) reestablishment procedure to restore connectivity over the backhaul link and informing the network node that a beam of the control link is still in good condition.

30. The method according to claim 29, wherein the indication that a beam failure was detected on the backhaul link is transmitted over the control link and comprises a single bit having a value indicating beam failure detection (BFD) on the backhaul link.

31. The method according to claim 30, wherein the indication that a beam failure was detected on the backhaul link further comprises indication of one or more of the following:
which beam was selected as outcome of the BFD;
a set of preferred beams to which the second module (NCR-Fwd) may be switched to maintain a connection with the network node over the backhaul link;
a beam that the second module (NCR-Fwd) has been switched to; and
a current status of the second module (NCR-Fwd) regardless of what was previously indicated by the network node.

32. The method according to claim 29, wherein the indication that the second module (NCR-Fwd) has been autonomously switched to another beam is transmitted over the control link and comprises a single bit having a value indicating a beam on which the second module (NCR-Fwd) is currently operating.

33. The method according to claim 32, wherein the indication that the second module (NCR-Fwd) has been autonomously switched to another beam further comprises indication of one or more of the following:
which beam was selected as outcome of beam failure detection (BFD);
a set of preferred beams to which the second module (NCR-Fwd) may be switched to maintain a connection with the network node over the backhaul link; and
a current status of the second module (NCR-Fwd) regardless of what was previously indicated by the network node.

34. The method according to claim 22, wherein when beam failure was detected on the backhaul link and on the control link, initiating a recovery procedure comprises initiating a radio resource control (RRC) reestablishment procedure to restore connectivity with the network node on both the backhaul link and control link.

35. The method according to claim 22, wherein the first module (NCR-MT) performs the beam monitoring on beams of the control link and one of the following applies:
the first module (NCR-MT) also performs the beam monitoring on beams of the backhaul link; or
the second module (NCR-Fwd) performs the beam monitoring on beams of the backhaul link and informs the first module (NCR-MT) when a beam failure is detected.

36. A method performed by a network node of a wireless communication network, the method comprising:
receiving, from a communication device having a first module (NCR-MT) configured to communicate with the network node via a control link and a second module 8NCR-Fwd) configured to communicate with the network node via a backhaul link, an indication of a type of beam failure detected by the communication device based on beam monitoring of the control link and of the backhaul link; and
transmitting to the communication device a configuration to restore connectivity to the communication device, wherein the configuration is based on the indicated type of beam failure.

37. The method according to claim 36, wherein the type of the beam failure detected by the communication device is one or more of the following:
a beam failure on the control link with no beam failure on the backhaul link;
a beam failure on the backhaul link with no beam failure on the control link; or
beam failures on both the control link and the backhaul link.

38. The method according to claim 37, wherein the type of the beam failure is beam failures on both the control link and the backhaul link when one or more of the following conditions are fulfilled:
the beam failure was detected on one of the control link and the backhaul link within a time period after the beam failure was detected on the other of the control link and the backhaul link;
the beam failure was detected on one of the control link and the backhaul link before a connectivity was restored on the other of the control link and the backhaul link; and
the beam failure was detected on one of the control link and the backhaul link before a recovery procedure was initiated by the communication device on the other of the control link and the backhaul link.

39. The method according to claim 36, wherein the indication of the type of beam failure detected by the communication device is received together with an indication of one or more of the following:
which beam was selected by the communication device as an outcome of the beam monitoring;
a set of preferred beams to which the second module (NCR-Fwd) can be switched in order to maintain the connection with the network node over the backhaul link;
a beam that the second module (NCR-Fwd) has been switched to; and
a current status of the second module (NCR-Fwd) regardless of what was previously indicated by the network node.

40. The method according to claim 36, wherein the configuration transmitted by the network node comprises one or more of the following:
an index of a beam to which the second module (NCR-Fwd) needs to be switched;
a new status for the second module (NCR-Fwd);
an index of a beam to which the first module (NCR-MT) needs to be switched;
a new set of parameters or values or fields to be used by the first module (NCR-MT); and
a new set of parameters or values or fields to be used by the second module (NCR-Fwd).
